(19) United States
(12) Patent Application Publication
(10) Pub. No.: US 2025/0384314 A1
(43) Pub. Date: Dec. 18, 2025

(54) Refinement of Neural-Based Trajectory Predictions with Probabilistic Graphical Models

(71) Applicant: GDM Holding LLC, Mountain View, CA (US)

(72) Inventors: Miguel Lázaro-Gredilla, Union City, CA (US); Meet Kirankumar Dave, Milpitas, CA (US); Shrinu Kushagra, Fremont, CA (US); Xinghua Lou, Danville, CA (US); Kevin Patrick Murphy, Palo Alto, CA (US)

(21) Appl. No.: 19/241,221

(22) Filed: Jun. 17, 2025

Related U.S. Application Data
(60) Provisional application No. 63/660,884, filed on Jun. 17, 2024.

(51) Int. Cl. G06N 7/01

(52) U.S. Cl. CPC G06N 7/01

(57) ABSTRACT

Provided are systems and methods for generating refined agent trajectories, leveraging a combination of neural-based trajectory prediction systems and probabilistic graphical models (PGMs). In particular, example implementations of the present disclosure utilize a probabilistic graphical model to refine agent trajectories initially predicted by a neural-based system, enhancing their adherence to fundamental movement constraints such as smooth trajectory continuity and realistic acceleration patterns. This refinement process ensures that the trajectories are not only more accurate but also comply with certain physical and practical constraints.

### RELATED APPLICATIONS

This application claims priority to and the benefit of U.S. Provisional Patent Application No. 63/660,884, filed Jun. 17, 2024, and titled Refinement of Neural-Based Trajectory Predictions with Probabilistic Graphical Models. U.S. Provisional Patent Application No. 63/660,884 is hereby incorporated by reference in its entirety.

### FIELD

The present disclosure relates generally to machine learning technologies and robotics. More particularly, the present disclosure relates to predicting (e.g., simulating) trajectories of multiple interacting agents based on neural networks (e.g., transformers) and probabilistic graphical models (PGMs).

### BACKGROUND

In the field of autonomous robotics, trajectory prediction for other agents in an environment is a central component, particularly for robotic devices that must navigate complex environments which include many different agents. The current state-of-the-art for trajectory prediction predominantly employs neural-based models, which are trained on extensive datasets to predict the movements of other agents within the environment. While these neural-based systems are capable of providing high accuracy on average, their reliance on purely learned data patterns without integrating established physical motion principles can occasionally lead to significant drawbacks.

Specifically, neural-based predictions, though generally effective, can occasionally predict trajectories for agents in an environment that deviate substantially from fundamental physical laws of motion or other reliable assumptions about agent behavior. These deviations might manifest as predicted movements which are erratic or unexpected or that do not conform to basic principles such as smooth trajectory continuity or realistic acceleration and deceleration patterns. Such anomalies in trajectory prediction can cause robotic devices which rely upon the predicted trajectories for other agents to also themselves exhibit unpredictable or incorrect behavior, potentially leading to operational inefficiencies, increased risk of collisions, or failure to achieve designated tasks within expected parameters.

Thus, there is a need for an improved approach in trajectory prediction that can mitigate the limitations of current neural-based systems. The ability to ensure that predicted trajectories consistently adhere to well-understood physical and practical constraints can enhance the reliability and safety of autonomous robotic operations in varied and dynamic environments.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to generate refined agent trajectories. The method includes obtaining, by a computing system comprising one or more computing devices, a plurality of predicted trajectories respectively associated with a plurality of agents in an environment, wherein the plurality of predicted trajectories have been predicted for the plurality of agents by a neural-based trajectory prediction system comprising one or more artificial neural networks. The method includes processing, by the computing system, the plurality of predicted trajectories with a probabilistic graphical model to generate a plurality of refined trajectories respectively for the plurality of agents as an output of the probabilistic graphical model, wherein the probabilistic graphical model comprises one or more factors that encode prior knowledge about agent motion. The method includes providing, by the computing system, at least one data element of at least one of the plurality of refined trajectories as an output.

Example implementations can include any combination of the following features. In some implementations, processing, by the computing system, the plurality of predicted trajectories with the probabilistic graphical model to generate the plurality of refined trajectories comprises: generating, by the computing system, a plurality of candidate trajectories as an output of the probabilistic graphical model; determining, by the computing system, a plurality of energy values respectively for the plurality of candidate trajectories; selecting, by the computing system, the plurality of refined trajectories from the plurality of candidate trajectories based on the plurality of energy values. In some implementations, generating, by the computing system, the plurality of candidate trajectories comprises jointly generating, by the computing system, the plurality of candidate trajectories for all of the plurality of agents. In some implementations, the probabilistic graphical model comprises one or more factors that encode a preference for smooth trajectories. In some implementations, the probabilistic graphical model comprises one or more factors that encode a preference for trajectories that avoid collision with static obstacles contained in the environment. In some implementations, the probabilistic graphical model comprises one or more factors that encode a preference for trajectories that avoid collision with other agents in the environment. In some implementations, at least one of the factors penalizes, for each agent, a distance between a candidate trajectory for such agent and the predicted trajectory for such agent. In some implementations, at least one of the factors penalizes, for each agent, a distance between a final data element in a candidate trajectory for such agent and a predicted goal location for such agent. In some implementations, at least one of the factors penalizes, for each agent, a distance between a candidate trajectory for such agent and a linear motion term. In some implementations, at least one of the factors penalizes, for each agent, a change in direction contained in a candidate trajectory for such agent. In some implementations, at least one of the factors penalizes, for each agent, an overlap between a field defined from a candidate trajectory for such agent and one or more road edges. In some implementations, at least one of the factors penalizes, for each agent, an overlap between a field defined from a candidate trajectory for such agent and one or more collision checking points for one or more other agents. In some implementations, processing, by the computing system, the plurality of predicted trajectories with the probabilistic graphical model to generate the plurality of refined trajectories comprises performing, by the computing system, approximate maximum a posteriori estimation on the probabilistic graphical model. In some implementations, the probabilistic graphical model comprises a plurality of factors; and processing, by the computing system, the plurality of predicted trajectories with the probabilistic graphical model to generate the plurality of refined trajectories comprises: performing, by the computing system, a Gauss-Newton method to solve a partial individual trajectory model comprising only a first subset of the plurality of factors to obtain smoothed trajectories for the agents, the first subset of the plurality of factors comprising factors that do not consider inter-agent interactions; and sampling, by the computing system, joint trajectories for the agents based on the smoothed trajectories and scoring the joint trajectories based on a second subset of the plurality of factors, the second subset of the plurality of factors comprising factors that consider inter-agent interactions; and selecting, by the computing system, one or more of the joint trajectories for each agent based on the scores generated from the second subset of the plurality of factors. In some implementations, processing, by the computing system, the plurality of predicted trajectories with the probabilistic graphical model to generate the plurality of refined trajectories comprises processing, by the computing system, the plurality of predicted trajectories with the probabilistic graphical model conditioned on scene context data that describes the environment. In some implementations, each of the plurality of refined trajectories comprises a series of agent states over a plurality of future timesteps, each agent stage comprises values for location and velocity, and wherein providing, by the computing system, at least one data element of at least one of the plurality of refined trajectories as the output comprises providing, by the computing system, a respective next agent state for each of the plurality of refined trajectories as the output. In some implementations, the neural-based trajectory prediction system comprises a motion transformer system that comprises one or more transformer neural networks. In some implementations, the method is performed iteratively over a number of sequential timesteps in a model predictive control or model predictive simulation setting. In some implementations, the plurality of agents in the environment comprises a plurality of simulated agents in a simulated environment. In some implementations, the plurality of agents in the environment comprises a plurality of observed agents in a real-world environment. In some implementations, the method further includes training, by the computing system, at least one artificial neural network on at least a portion of the plurality of refined trajectories. In some implementations, the at least one artificial neural network is at least one of the one or more artificial neural networks of the neural-based trajectory prediction system. In some implementations, the at least one artificial neural network is at least one of a second one or more artificial neural networks of a second neural-based trajectory prediction system. In some implementations, the second neural-based trajectory prediction system is distinct from the first neural-based trajectory prediction system. In some implementations, the environment comprises a roadway and the plurality of agents comprise humanly-operated vehicles, autonomous vehicles, pedestrians, cyclists, or combinations thereof. In some implementations, the method further includes controlling, by the computing system, motion of an autonomous robotic device based at least in part on the output comprising the at least one data element of the at least one of the plurality of refined trajectories.

A computing system can be configured to perform the method described above. An autonomous robotic device can be configured to perform the method described above. One or more non-transitory computer-readable media can store one or more artificial neural networks that have been trained using refined trajectories generated by performance of the method described above. Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

The attached Appendix, which is fully incorporated into and forms a portion of this disclosure, describes example implementations of the systems and methods described herein. The present disclosure is not limited to the example implementations described in the attached Appendix.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates a block diagram of an example trajectory prediction system according to example embodiments of the present disclosure.

FIG. 2 illustrates a flowchart diagram of an example method for refining trajectory predictions according to example embodiments of the present disclosure.

FIG. 3 illustrates a graphical diagram of an example probabilistic graphical model according to example embodiments of the present disclosure.

FIG. 4A depicts a block diagram of an example computing system that performs trajectory prediction according to example embodiments of the present disclosure.

FIG. 4B depicts a block diagram of an example computing device that performs trajectory prediction according to example embodiments of the present disclosure.

FIG. 4C depicts a block diagram of an example computing device that performs trajectory prediction according to example embodiments of the present disclosure.

Reference numerals that are repeated across plural figures are intended to identify the same features in various implementations.

### DETAILED DESCRIPTION

The present disclosure provides systems and methods for generating refined agent trajectories, leveraging a combination of neural-based trajectory prediction systems and probabilistic graphical models (PGMs). In particular, example implementations of the present disclosure utilize a probabilistic graphical model to refine agent trajectories initially predicted by a neural-based system, enhancing their adherence to fundamental movement constraints such as smooth trajectory continuity and realistic acceleration patterns. This refinement process ensures that the trajectories are not only more accurate but also comply with certain physical and practical constraints.

More particularly, in the context of robotic systems, the term “agents” can refer broadly to entities that can perform actions and make decisions based on their environment and objectives. These agents can be physical entities, such as vehicles, robots, and pedestrians, or virtual entities in simulations. To provide an example, an autonomous robotic device may be present in a warehouse and may observe other agents within the warehouse (e.g., other autonomous robot devices and/or humans). The ability of the autonomous robotic device to accurately predict the movement (e.g., represented as trajectories) for these observed agents enables the autonomous robotic device to control its own movement in the appropriate manner (e.g., avoid collisions). Prediction of trajectories in simulated environments can also be useful for training and/or testing systems prior to deployment in real-world settings. Thus, whether in real-world settings or simulations, accurate trajectory prediction enables proactive planning and response strategies, allowing for smoother operations and the achievement of specific operational goals.

As described above, current state-of-the-art trajectory prediction systems rely on neural-based predictions. However, neural-based predictions, though generally effective, can occasionally predict trajectories for agents in an environment that deviate substantially from fundamental physical laws of motion or other reliable assumptions about agent behavior.

Thus, one aspect of the present disclosure is directed to a trajectory refinement system that can leverage one or more structured graphical models such as probabilistic graphical models to refine neural-based trajectory predictions to demonstrate improved adherence to certain motion constraints or assumptions.

In particular, a neural-based system can function to generate initial predicted trajectories for multiple agents within a given environment. This system, which may include one or more neural networks such as transformer neural networks, can leverage extensive datasets to learn patterns and behaviors of agent movements. For instance, the system might analyze historical data from traffic flows or robotic movements in industrial settings to predict future locations and paths of agents. By processing this data, the neural network can output a set of initial trajectories for each agent, which reflect likely movements based on learned data correlations and trends. These initial predictions provide an initial prediction for further refinement.

In particular, according to an aspect of the present disclosure, a trajectory refinement system can use a probabilistic graphical model to process (e.g., “post-process”) the predicted trajectories provided by the neural-based system. This probabilistic graphical model can incorporate various factors that encode prior knowledge about typical agent motion, such as preferences for maintaining smooth trajectories, avoiding collisions, and/or adhering to scene-based or map-based behavioral expectations or rules. These factors are beneficial in refining the raw predictions from the neural network by aligning them more closely with realistic motion patterns and environmental constraints.

Probabilistic graphical models are a class of statistical models that represent the dependencies between variables through a graph structure, and “factors” within these models are functions that define the relationships and constraints between these variables to capture the joint probability distribution. As one example, in some implementations, the proposed probabilistic graphical models can include specific factors that promote smoothness in the trajectories. For example, these factors can penalize deviations from a linear path or sudden changes in direction. By prioritizing smoothness, the system can predict more realistic and mechanically feasible paths for the agents.

As another example, in some implementations, the proposed probabilistic graphical models can include specific factors that promote collision avoidance with static objects and/or other agents in the environment. For example, the probabilistic graphical model can use factors that specifically focus on preventing collisions with both static obstacles, like road barriers, and other moving agents. These factors can be particularly beneficial in densely populated environments, such as urban centers, where the potential for interactions among agents is high.

As another example, in some implementations, the proposed probabilistic graphical models can include specific factors that penalize trajectories that diverge significantly from the initial predictions or that fail to converge on designated goal locations. This ensures that the refined trajectories do not overly deviate from the initial neural-predicted trajectories.

As another example, in some implementations, the proposed probabilistic graphical models can include specific factors that adjust the trajectories based on their adherence to expected motion laws, such as maintaining a consistent velocity or following a predefined route.

In some implementations, the trajectory refinement system can generate multiple candidate trajectories for each agent and can evaluate these trajectories based on their calculated energy levels. This process can include, for instance, comparing each candidate trajectory's adherence to expected motion paths and its avoidance of static and dynamic obstacles. The trajectories with the lowest energy values, which represent the most probable and optimal paths, can then be selected as the refined trajectories.

In some implementations, to perform inference over the probabilistic graphical model, the trajectory refinement system can utilize a Gauss-Newton method to optimize the trajectories. This approach can efficiently handle the non-linear and non-convex nature of the trajectory optimization problem, particularly when initial trajectory smoothing is required. In particular, a two-step inference process can first smooth the trajectories using a subset of factors and can then evaluate joint trajectories considering interactions among agents. Gauss-Newton is provided as one example, other alternative approaches to optimization can also be used, such as, for example, the Levenberg-Marquardt algorithm.

Thus, in some implementations, the trajectory refinement system can perform joint trajectory generation for all agents involved. This approach can ensure that the trajectories are not only optimized for individual agents but also for the group dynamics, which enables the generation of more accurate agent trajectories in environments where agent paths may intersect or influence each other.

In some implementations, the proposed trajectory refinement approach can be performed iteratively over a number of timesteps, where refinement is performed at each timestep. For example, performing the refinement in this manner can enable the proposed approach to be applied in model predictive control (MPC) settings, where conditions can change rapidly, and continuous adaptation is necessary. Furthermore, applying the proposed techniques iteratively within a simulated environment can be referred to as model predictive simulation (MPS).

The proposed techniques can be applied to various types of agents and environments. As examples, the agents can be autonomous vehicles or other agents in a real-world or simulated cityscape, agents in a factory, warehouse, or industrial setting, characters in a video game, or other uses or settings.

The systems and methods of the present disclosure provide a number of technical effects and benefits. As one example, the proposed techniques improve the accuracy of trajectory predictions by integrating a probabilistic graphical model with a neural-based trajectory prediction system. This integration allows for the refinement of initial trajectory predictions by incorporating factors that encode prior knowledge about agent behaviors and environmental constraints, such as the preference for smooth trajectories, avoidance of collisions, and/or adherence to scene-based or map-based behavioral expectations or rules. The refined trajectories are practical, achievable paths that agents can realistically follow, thereby reducing errors in simulation and real-world applications.

As another example, the disclosed techniques can operate within or be applied to settings that demonstrate dynamic changes. For example, by implementing the proposed techniques within a model predictive control or model predictive simulation framework, the refinement system can iteratively refine predictions and adapt to changes in the environment or agent behaviors. This continuous adaptation process is enabled by the method's capability to reassess and adjust the trajectories at each timestep based on the latest data, thereby ensuring that the system's outputs remain relevant and accurate over time.

As another example technical effect, the proposed techniques effectively address complex scenarios involving multiple interacting agents by generating joint trajectories that consider the interactions and dependencies among agents. The ability to generate and evaluate joint trajectories based on a comprehensive set of factors, including those that penalize potential collisions and deviations from expected paths, ensures that the system can optimize the collective prediction for all agents. This optimization leads to enhanced overall system efficiency and safety, providing a technical solution to the challenge of predicting the behavior of multiple agents in shared spaces.

As another example, the present disclosure provides a substantial benefit by enabling the use of refined trajectories, generated through the proposed PGM-based system, to train and/or test neural networks. For example, this training approach can involve distillation techniques where a neural network learns to directly predict the refined trajectories, thereby inheriting the accuracy and reliability of the PGM enhancements. Additionally or alternatively, the refined trajectories can be used to create realistic simulation environments for training or testing neural networks, ensuring that the networks are exposed to (e.g., trained on or tested with respect to) more accurate agent behaviors. In both scenarios, the resulting trained neural networks are equipped to offer superior trajectory prediction capabilities. This directly translates to more precise and reliable navigation and task execution in real-world applications, thereby providing a technical advancement in the field of autonomous systems.

Example outer loop: An example of an overall simulation pseudocode is shown in Algorithm 1. It generates a set of K=32 trajectories, each of length T=80, for N agents given the scene context c. (The exact value of N depends on the number of agents that are visible in c.) The generated output can be denoted by

$${s}_{1 : N}^{1 : K , 1 : T} ,$$

where

$${s}_{i}^{k , t} = [ x , y , \dot{x} , \dot{y} ]$$

is the state (e.g., 2D location and velocity) of the i′th agent in sample k.

Algorithm 1: SimAgents outer loop:

```
Input: Scene context c, num. agents N, num. samples K, trajectory length
T
$Output : Sampled trajectories {h}_{1 : N}^{1 : K , 1 : T}$
for k = 1 to K do
  ${s}_{1 : N}^{k , 0} = init - trajectory ( c )$
  for t = 1 to T do
    $Sample {r}_{1 : N}^{k , t} = MPS ( c , {s}_{1 : N}^{k , 1 : t - 1} )$
    $Extend {s}_{1 : N}^{k , 1 : t} = append ( {s}_{1 : N}^{k , 1 : t} , {r}_{1 : N}^{k , t} )$
  end
end
```

Example inner loop: At each step t, the simulator can call an MPS algorithm to generate a prediction for the next state of each agent. An example pseudocode for this is shown in Algorithm 2, below.

Algorithm 2: Model Predictive Simulation:

```
Input: Scene context c, agent history h_{1:N}, num. agents N, future planning horizon F,
number of rollouts J, transformer proposal π
Output: Predicted next state for each agent, r_{1:N}
for j = 1 to J do
  $Sample ( {a}_{1 : N}^{j , 1 : F} , {g}_{1 : N}^{j} ) ∼ π ( c , {h}_{1 : N} , F )$
  ${G}^{j} = BuildFactorGraph ( {a}_{1 : N}^{j , 1 : F} , {g}_{1 : N}^{j} , c )$
  $Initialize {s}_{1 : N}^{j , 1 : F} = {a}_{1 : N}^{j , 1 : F}$
  $( {s}_{1 : N}^{j , 1 : F} , {E}^{j} ) = Inference ( {G}^{j} , {s}_{1 : N}^{j , 1 : F} )$
end
Sample j* ~ SoftMin(E^{1:J})
$return {s}_{1 : N}^{{j}^{*} , 1}$
```

Thus, one example approach is as follows. First use a transformer model π to sample a set of N goal locations,

$${g}_{1 : N}^{j} ,$$

one for each agent, as well as a sequence of anchor points leading to each goal,

$${a}_{1 : N}^{j , 1 : F} ,$$

where F is the planning or forecast horizon. Some example implementations can do this J=60 times in parallel, to create a set of possible futures. Some example implementations can then use the PGM to generate/joint trajectories (for all N agents), using the methods described herein. Finally some example implementations evaluate the energy of each generated trajectory, E^{j}, sample one of the low energy (high probability) ones to get

$${s}_{1 : N}^{{j}^{*} , 1 : F} ,$$

and return the first step of this sampled trajectory,

$${s}_{1 : N}^{{j}^{*} , 1} .$$

One example joint probability model can be represented as:

$$p ( {s}_{1 . . N}^{1 : F} \vert c , {a}_{1 : N}^{1 : F} , {g}_{1 : N} ) ∝ {\prod }_{i = 1}^{N} [ {f}_{G} ( {s}_{i}^{F} \vert {g}_{i} ) \cdot {\prod }_{t = 1}^{F - 1} {f}_{M} ( {s}_{i}^{t} \vert {a}_{i}^{t} ) ] \cdot {\prod }_{i = 1}^{N} [ {\prod }_{t = 2}^{F} {f}_{L} ( {s}_{i}^{t - 1} , {s}_{i}^{t} ) \cdot {f}_{A} ( {s}_{i}^{t - 1} , {s}_{i}^{t} ) \cdot {\prod }_{i = 1}^{N} {\prod }_{t = 1}^{F} {f}_{O} ( {s}_{i}^{t} \vert c ) \cdot {\prod }_{i \neq j} {\prod }_{t = 1}^{F} {f}_{C} ( {s}_{i}^{t} , {s}_{j}^{t} )$$

Example Graphical Model: Aspects of the present disclosure leverage a probabilistic graphical model (PGM) for improving upon the proposed trajectories by a neural model (e.g., a transformer model). The following paragraphs explain each of several example factors which can be used in varying combinations.

First, some example implementations use factors which compare a candidate trajectory to the original proposal. The motion factor is defined as

$${f}_{M} ( {s}_{i}^{t} ) = \vert {s}_{i}^{t} - {a}_{i}^{t} \vert ,$$

where

$${a}_{i}^{t}$$

is the predicted location (anchor point) for agent i at time t as computed by T. This ensures the trajectory stays close to the initial proposal. The proximity to goal factor is defined as

$${f}_{G} ( {s}_{i}^{F} ) = \vert {s}_{i}^{F} - {g}_{i} \vert ,$$

where gᵢ is the goal for agent i predicted by π. This ensures the trajectory ends close to an expected termination location.

Second, some example implementations use factors defined from physical motion constraints. Some example implementations define a factor that penalizes deviation from linear motion:

$${f}_{L} ( s , {s}^{′} ) = \vert {s}_{xy}^{′} - ( {s}_{xy} + {s}_{\dot{x} \dot{y}} {Δ}_{t} ) \vert ,$$

where s_{xy} are the location components of s, s_{\dot{x}\dot{y}} are the velocity components of s, and Δt is the sampling rate. Some example implementations also define a factor that penalizes change in direction: f_{A}(s, s′)=|s_{\dot{x}\dot{y}}−s′_{\dot{x}\dot{y}}|. Some example implementations use weight 2.0 for f_{A} and 1.0 for all other factors.

Third, some example implementations use factors derived from static obstacles on the road: f_{O}(s|c)=max_{(x,y)∈c}_{_{RE}}G(x, y|s), where CRE represents the coordinates of the road edges (part of the context c) and G(x, y|s) is a Gaussian field centered and rotated according to the agent's location s_{xy}.

Finally, some example implementations have pairwise collision factors between agents: f_{C}(s, s′)=max_{(x,y)∈CCP(s′)}G(x, y|s), where G(x, y|s) is a Gaussian field for agent s, and CCP(s′) are the 9 collision checking points (CCP) for the other agent s′ (4 corners, 4 centers of the sides, and center of the agent).

Example inference approach: In some implementations, inference on the factor graph is equivalent to minimizing a non-linear, non-convex quadratic optimization problem defined over

$${S}_{1 : N}^{1 : F} .$$

For efficiency reasons, some example implementations leverage a two-step approach. First, some example implementations use the Gauss-Newton method to solve a partial model that only consists of f_{M}, f_{L} and f_{A} factors, as these can all be evaluated in parallel across agents using N individual trajectory models. This step produces smoothed trajectories, which are then frozen. Second, some example implementations sample joint trajectories for agents according to their probability (unnormalized energy), and use the f_{O} and f_{C} factors to score their quality. After repeating this J times, the best joint trajectories can be sampled from a softmin operation over the scores of the J samples.

With reference now to the Figures, example embodiments of the present disclosure will be discussed in further detail.

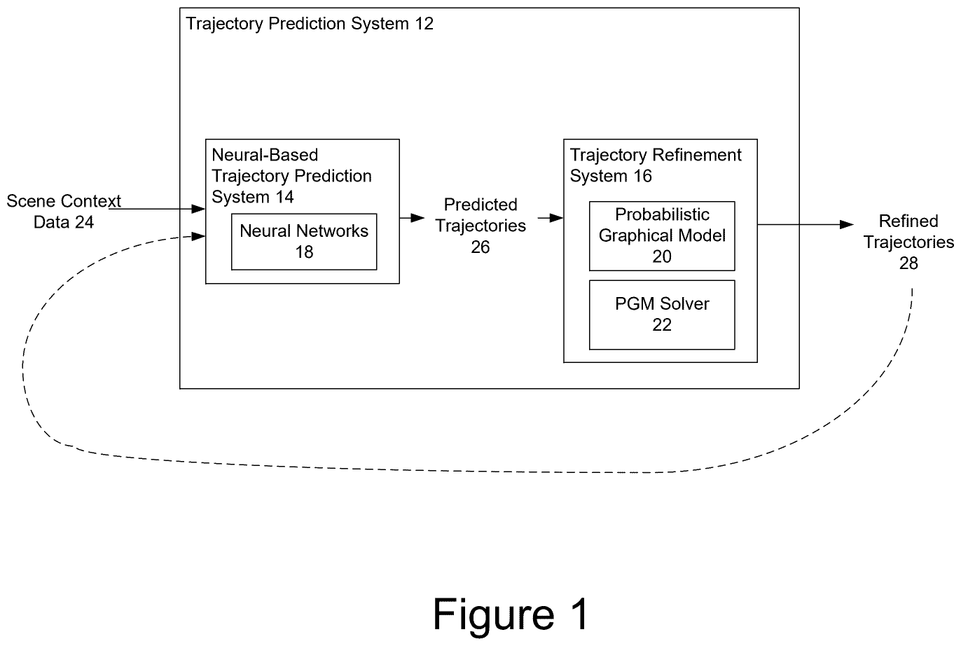

Referring now to FIG. 1, a schematic diagram of an example trajectory prediction system 12 is depicted. The trajectory prediction system 12 comprises two primary components: a neural-based trajectory prediction system 14 and a trajectory refinement system 16. The trajectory prediction system 12 operates to refine and enhance the accuracy of trajectory predictions for multiple agents within a given environment.

The neural-based trajectory prediction system 14 utilizes neural networks 18 to process scene context data 24. Scene context data 24 can include various types of environmental and situational information, such as geographic, temporal, and activity-related data pertaining to the agents and their surroundings. For example, scene context data 24 can include mapping data or other geospatial data. As another example, scene context data 24 can include perceptual data (or inferences derived from perceptual data) which has been collected by various sensors such as cameras, LiDAR systems, RaDAR systems, etc. The neural networks 18 are trained to analyze this data and generate predicted trajectories 26 for the agents. These trajectories represent the initial estimations of the paths that the agents are likely to take based on the learned patterns from historical and contextual data.

Following this, the predicted trajectories 26 are input into the trajectory refinement system 16. This system includes a probabilistic graphical model 20 and a PGM solver 22. The probabilistic graphical model 20 utilizes various factors that encode prior knowledge about typical agent motion, such as preferences for maintaining smooth trajectories, avoiding collisions, and/or adhering to scene-based or map-based behavioral expectations or rules. These factors are used to adjust and refine the predicted trajectories 26 to ensure they adhere more closely to realistic motion patterns and environmental constraints.

The PGM solver 22 is responsible for performing optimization operations on the probabilistic graphical model 20. For example, the PGM solver 22 can perform computational techniques to optimize the trajectory predictions, ensuring that the refined trajectories are both probable and optimal given the current environmental context and the inherent motion characteristics of the agents. The output of this process is the refined trajectories 28, which are trajectories that have been adjusted to account for additional physical and practical constraints, enhancing their reliability and accuracy.

In some implementations, the solver 22 can perform optimization techniques to estimate the parameters of the model, such as, for example, the Gauss-Newton and Levenberg-Marquardt algorithms. In some implementations, the PGM solver 22 can also generate samples from the probabilistic graphical model 20. In some examples, the solver 22 can utilize forward sampling, rejection sampling, Gibbs sampling, and/or Markov Chain Monte Carlo (MCMC) methods.

In some implementations, the trajectory prediction system 12 can be configured to operate iteratively, where the scene context data 24 is continuously updated, and the neural networks 18 and PGM Solver 22 repetitively refine the trajectories in response to dynamic changes in the environment. This iterative process allows the system to adapt to new data in real-time, providing updated and accurate trajectory predictions that can be beneficial for applications such as autonomous vehicle navigation and robotic path planning in complex environments.

Alternative embodiments may include variations in the type and structure of the neural networks 18 and the probabilistic graphical model 20. For instance, different neural network architectures such as convolutional neural networks or recurrent neural networks could be employed depending on the specific requirements of the trajectory prediction tasks. Similarly, the probabilistic graphical model 20 may incorporate additional or alternative factors tailored to specific operational environments or agent types, enhancing the system's flexibility and applicability across various domains.

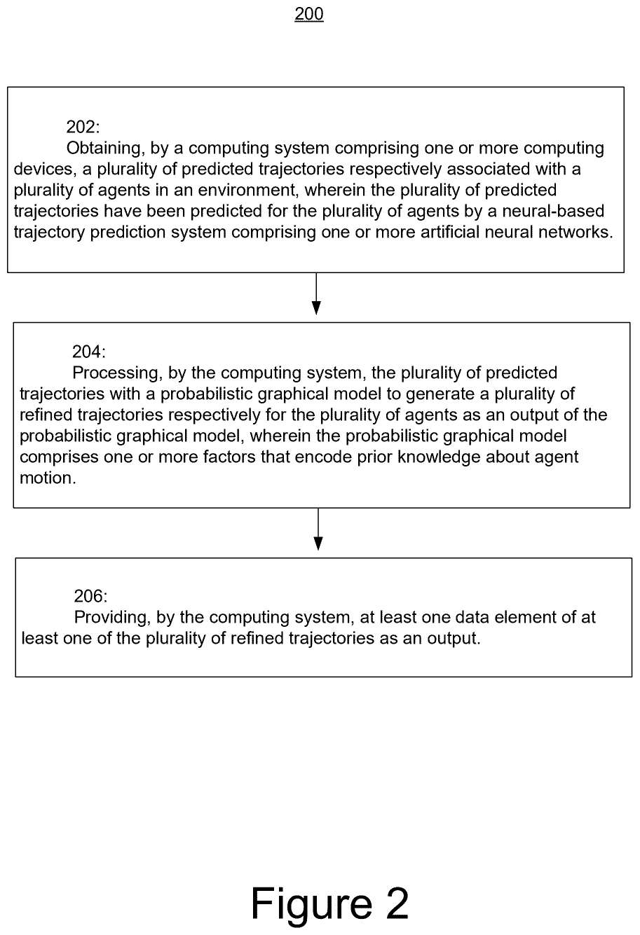

Referring now to FIG. 2, an example flowchart diagram 200 is illustrated, depicting a computer-implemented method for refining trajectory predictions according to example embodiments of the present disclosure. This method enhances the accuracy and reliability of trajectory predictions for multiple agents in dynamic environments.

In some implementations, the method begins with step 202, which includes obtaining, by a computing system comprising one or more computing devices, a plurality of predicted trajectories respectively associated with a plurality of agents in an environment. These predicted trajectories are generated by a neural-based trajectory prediction system that comprises one or more artificial neural networks.

In some implementations, the method proceeds to step 204, which involves processing, by the computing system, the plurality of predicted trajectories with a probabilistic graphical model to generate a plurality of refined trajectories respectively for the plurality of agents as an output of the probabilistic graphical model. The probabilistic graphical model used in this step comprises one or more factors that encode prior knowledge about agent motion, such as preferences for maintaining smooth trajectories, avoiding collisions, and/or adhering to scene-based or map-based behavioral expectations or rules. These factors may include, but are not limited to, a preference for smooth trajectories, a preference for trajectories that avoid collision with static obstacles contained in the environment, and a preference for trajectories that avoid collision with other agents in the environment.

In some implementations, the processing of the predicted trajectories with the probabilistic graphical model further comprises generating, by the computing system, a plurality of candidate trajectories as an output of the probabilistic graphical model. The computing system then determines a plurality of energy values respectively for the plurality of candidate trajectories and selects the plurality of refined trajectories from the plurality of candidate trajectories based on the plurality of energy values. This selection process may involve performing approximate maximum a posteriori estimation on the probabilistic graphical model.

In some implementations, the method includes step 206, which involves providing, by the computing system, at least one data element of at least one of the plurality of refined trajectories as an output. For example, this output can be used to control the motion of an autonomous robotic device or for other decision-making processes in dynamic environments.

In some implementations, the probabilistic graphical model used in the processing step includes factors that penalize deviations from expected motion paths, such as penalizing a distance between a candidate trajectory and the predicted trajectory for each agent, or penalizing changes in direction contained in a candidate trajectory for each agent.

In some implementations, the method is performed iteratively over a number of sequential timesteps in a model predictive control or model predictive simulation setting, allowing for continuous refinement of trajectories based on updated environmental data and/or agent states.

Through these implementations, the method effectively refines initial trajectory predictions, enhancing the safety and efficiency of operations involving multiple agents in dynamic and potentially crowded environments.

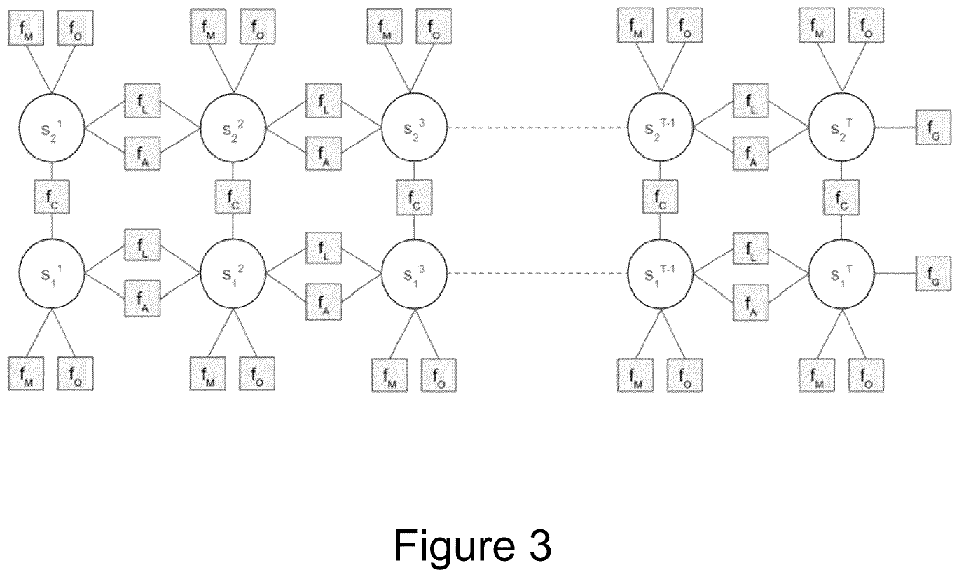

Referring now to FIG. 3, a graphical representation of a Factor Graph for some number of agents (e.g., N=2 agents) unrolled for some number of planning steps (e.g., T planning steps) is depicted. This diagram illustrates the probabilistic graphical model used to refine trajectory predictions by incorporating various factors that influence agent movements. The structure of the graph is designed to facilitate the computation of joint probabilities and to execute inference algorithms efficiently.

In the diagram, circles represent random variables, specifically the states

$$( {S}_{t}^{i} )$$

of each agent (i) at time (t). These states could include, for example, the position and velocity of the agents. The gray squares represent fixed factors, which are functions that define the relationships and constraints between the variables. These factors encode the prior knowledge and constraints that guide the trajectory refinement process.

Starting from the left, each agent's state at each timestep is connected to multiple example factors, such as:

Motion Factor ((f_{M})): This factor can penalize, for each agent, a distance between a candidate trajectory for such agent and the predicted trajectory for such agent.

Obstacle Avoidance Factor ((f_{O})): This factor can ensure that the trajectories avoid static obstacles in the environment.

Linear Factor ((f_{L})) and Adjustment Factor ((f_{A})): These can be used to ensure that the trajectory adheres to expected linear motion paths and minimizes significant changes in direction.

Collision Factor ((f_{C})): This factor can penalize trajectories that would lead to collisions between agents, thus it is repeated for interactions between each pair of agents across all timesteps.

Goal Factor ((f_{G})): Located at the final timestep for each agent, this factor ensures that the trajectory is directed towards the intended goal or endpoint.

The graph is unrolled over (T) timesteps, showing the progression of each agent's state from

$$( {S}_{1}^{i} )$$

to

$$( {S}_{T}^{i} ) .$$

The dashed lines between the timesteps indicate the continuation of the graph structure through time.

This structured approach allows for the use of advanced inference algorithms, such as the Gauss-Newton method mentioned earlier, to optimize the trajectories by minimizing a cost function defined by these factors. The factor graph provides an efficient way to represent and manipulate the dependencies and constraints that are used for generating refined trajectories. Gauss-Newton is provided as one example, other alternative approaches to optimization can also be used, such as, for example, the Levenberg-Marquardt algorithm.

In alternative embodiments, additional factors could be integrated into this model to accommodate different scenarios or additional constraints, such as energy efficiency, time optimization, or compliance with various traffic regulations. Furthermore, the model could be extended to handle a greater number of agents or more complex agent interactions, making it adaptable to a wide range of applications in both simulated and real-world environments.

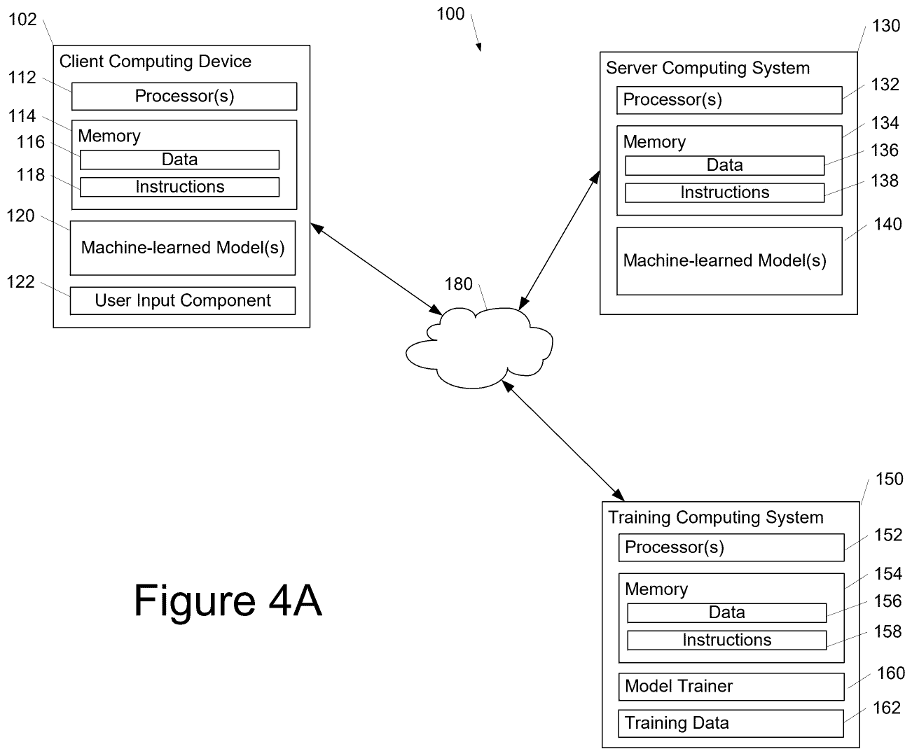

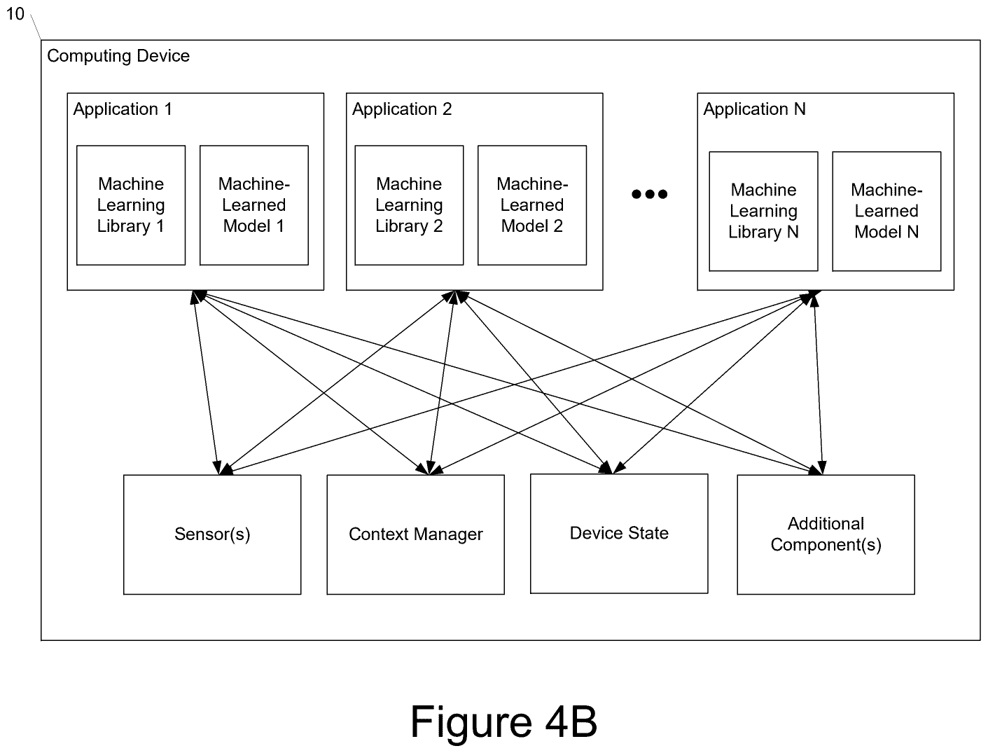

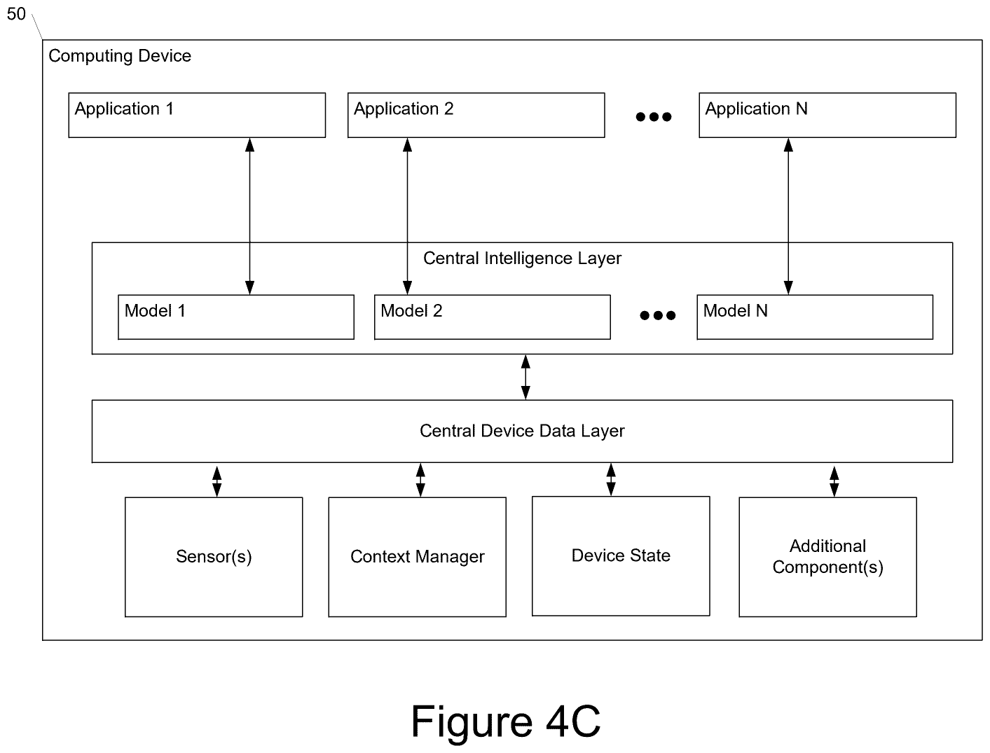

Referring now to FIG. 4A, FIG. 4A depicts a block diagram of an example computing system 100 that performs trajectory prediction according to example embodiments of the present disclosure. The system 100 includes a client computing device 102, a server computing system 130, and a training computing system 150 that are communicatively coupled over a network 180.

The client computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device. In some implementations, the client computing device 102 can be an autonomous robotic device.

The client computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the client computing device 102 to perform operations.

In some implementations, the client computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-3.

In some implementations, the one or more machine-learned models 120 can be received from the server computing system 130 over network 180, stored in the user computing device memory 114, and then used or otherwise implemented by the one or more processors 112. In some implementations, the client computing device 102 can implement multiple parallel instances of a single machine-learned model 120 (e.g., to perform parallel trajectory prediction across multiple instances of agents and/or scenes).

Additionally or alternatively, one or more machine-learned models 140 can be included in or otherwise stored and implemented by the server computing system 130 that communicates with the client computing device 102 according to a client-server relationship. For example, the machine-learned models 140 can be implemented by the server computing system 140 as a portion of a web service (e.g., a trajectory service). Thus, one or more models 120 can be stored and implemented at the client computing device 102 and/or one or more models 140 can be stored and implemented at the server computing system 130.

The client computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-3.

The client computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the client computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the client computing device 102. Thus, in such implementations, the model 120 provided to the client computing device 102 can be trained by the training computing system 150 on user-specific data received from the client computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 4A illustrates one example computing system that can be used to implement the present disclosure. Other computing systems can be used as well. For example, in some implementations, the client computing device 102 can include the model trainer 160 and the training dataset 162. In such implementations, the models 120 can be both trained and used locally at the client computing device 102. In some of such implementations, the client computing device 102 can implement the model trainer 160 to personalize the models 120 based on user-specific data.

Referring to FIG. 1 and FIG. 4A, the trajectory prediction system 12 can be implemented using various configurations involving the user computing device 102 and/or the server computing system 130. In one embodiment, the entire functionality of the trajectory prediction system 12 can be hosted and executed entirely on the user computing device 102, allowing for localized processing and decision-making without the need for constant connectivity to external servers. Alternatively, the trajectory prediction system 12 can be implemented entirely on the server computing system 130, leveraging more robust computational resources and centralized data management for processing large datasets and complex algorithms. This setup may be particularly beneficial for scenarios requiring intensive computational power or access to large, aggregated data sources. Lastly, a hybrid approach can be employed where some operations of the trajectory prediction system 12 are handled by the user computing device 102 while others are processed on the server computing system 130. This mixed approach allows for a balance between local processing speed and the powerful, centralized analytical capabilities of the server system, optimizing performance and scalability according to specific application needs. Each of these configurations offers unique advantages and can be selected based on factors such as required processing power, data sensitivity, and operational efficiency. For example, instructions 118 and/or instructions 138 can include instructions for implementing the trajectory prediction system 12.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to generate refined agent trajectories, the method comprising:
obtaining, by a computing system comprising one or more computing devices, a plurality of predicted trajectories respectively associated with a plurality of agents in an environment, wherein the plurality of predicted trajectories have been predicted for the plurality of agents by a neural-based trajectory prediction system comprising one or more artificial neural networks;
processing, by the computing system, the plurality of predicted trajectories with a probabilistic graphical model to generate a plurality of refined trajectories respectively for the plurality of agents as an output of the probabilistic graphical model, wherein the probabilistic graphical model comprises one or more factors that encode prior knowledge about agent motion; and
providing, by the computing system, at least one data element of at least one of the plurality of refined trajectories as an output.

2. The computer-implemented method of claim 1, wherein processing, by the computing system, the plurality of predicted trajectories with the probabilistic graphical model to generate the plurality of refined trajectories comprises:
generating, by the computing system, a plurality of candidate trajectories as an output of the probabilistic graphical model;
determining, by the computing system, a plurality of energy values respectively for the plurality of candidate trajectories; and
selecting, by the computing system, the plurality of refined trajectories from the plurality of candidate trajectories based on the plurality of energy values.

3. The computer-implemented method of claim 2, wherein generating, by the computing system, the plurality of candidate trajectories comprises jointly generating, by the computing system, the plurality of candidate trajectories for all of the plurality of agents.

4. The computer-implemented method of claim 1, wherein the probabilistic graphical model comprises one or more factors that encode a preference for smooth trajectories.

5. The computer-implemented method of claim 1, wherein the probabilistic graphical model comprises one or more factors that encode a preference for trajectories that avoid collision with static obstacles or other agents contained in the environment.

6. The computer-implemented method of claim 1, wherein at least one of the factors penalizes, for each agent, a distance between a candidate trajectory for such agent and the predicted trajectory for such agent.

7. The computer-implemented method of claim 1, wherein at least one of the factors penalizes, for each agent, a distance between a final data element in a candidate trajectory for such agent and a predicted goal location for such agent.

8. The computer-implemented method of claim 1, wherein at least one of the factors penalizes, for each agent, a distance between a candidate trajectory for such agent and a linear motion term.

9. The computer-implemented method of claim 1, wherein at least one of the factors penalizes, for each agent, a change in direction contained in a candidate trajectory for such agent.

10. The computer-implemented method of claim 1, wherein at least one of the factors penalizes, for each agent, an overlap between a field defined from a candidate trajectory for such agent and one or more road edges.

11. The computer-implemented method of claim 1, wherein at least one of the factors penalizes, for each agent, an overlap between a field defined from a candidate trajectory for such agent and one or more collision checking points for one or more other agents.

12. The computer-implemented method of claim 1, wherein processing, by the computing system, the plurality of predicted trajectories with the probabilistic graphical model to generate the plurality of refined trajectories comprises performing, by the computing system, approximate maximum a posteriori estimation on the probabilistic graphical model.

13. The computer-implemented method of claim 1, wherein:
the probabilistic graphical model comprises a plurality of factors; and
processing, by the computing system, the plurality of predicted trajectories with the probabilistic graphical model to generate the plurality of refined trajectories comprises:
performing, by the computing system, a Gauss-Newton method to solve a partial individual trajectory model comprising only a first subset of the plurality of factors to obtain smoothed trajectories for the agents, the first subset of the plurality of factors comprising factors that do not consider inter-agent interactions; and
sampling, by the computing system, joint trajectories for the agents based on the smoothed trajectories and scoring the joint trajectories based on a second subset of the plurality of factors, the second subset of the plurality of factors comprising factors that consider inter-agent interactions; and
selecting, by the computing system, one or more of the joint trajectories for each agent based on the scores generated from the second subset of the plurality of factors.

14. The computer-implemented method of claim 1, wherein processing, by the computing system, the plurality of predicted trajectories with the probabilistic graphical model to generate the plurality of refined trajectories comprises processing, by the computing system, the plurality of predicted trajectories with the probabilistic graphical model conditioned on scene context data that describes the environment.

15. The computer-implemented method of claim 1, wherein the plurality of agents in the environment comprises a plurality of simulated agents in a simulated environment.

16. The computer-implemented method of claim 1, wherein the plurality of agents in the environment comprises a plurality of observed agents in a real-world environment.

17. The computer-implemented method of claim 1, further comprising:
training, by the computing system, at least one artificial neural network on at least a portion of the plurality of refined trajectories.

18. The computer-implemented method of claim 1, further comprising:
controlling, by the computing system, motion of an autonomous robotic device based at least in part on the output comprising the at least one data element of the at least one of the plurality of refined trajectories.

19. A computing system comprising one or more processors and one or more non-transitory computer-readable media that collectively store instructions that, when executed by the one or more processors, cause the computing system to perform operations, the operations comprising:
obtaining, by the computing system, a plurality of predicted trajectories respectively associated with a plurality of agents in an environment, wherein the plurality of predicted trajectories have been predicted for the plurality of agents by a neural-based trajectory prediction system comprising one or more artificial neural networks;
processing, by the computing system, the plurality of predicted trajectories with a probabilistic graphical model to generate a plurality of refined trajectories respectively for the plurality of agents as an output of the probabilistic graphical model, wherein the probabilistic graphical model comprises one or more factors that encode prior knowledge about agent motion; and
providing, by the computing system, at least one data element of at least one of the plurality of refined trajectories as an output.

20. An autonomous robotic device configured to perform operations, the operations comprising:
obtaining, by the autonomous robotic device, a plurality of predicted trajectories respectively associated with a plurality of agents in an environment, wherein the plurality of predicted trajectories have been predicted for the plurality of agents by a neural-based trajectory prediction system comprising one or more artificial neural networks;
processing, by the autonomous robotic device, the plurality of predicted trajectories with a probabilistic graphical model to generate a plurality of refined trajectories respectively for the plurality of agents as an output of the probabilistic graphical model, wherein the probabilistic graphical model comprises one or more factors that encode prior knowledge about agent motion;
providing, by the autonomous robotic device, at least one data element of at least one of the plurality of refined trajectories as an output; and
autonomously controlling, by the autonomous robotic device, motion of the autonomous robotic device based on the output.
